(19) United States
(12) Patent Application Publication
(10) Pub. No.: US 2024/0394570 A1
(43) Pub. Date: Nov. 28, 2024

(54) DEVICE AND COMPUTER IMPLEMENTED METHOD FOR MACHINE LEARNING

(71) Applicant: Robert Bosch GmbH, Stuttgart (DE)

(72) Inventors: Youmna Salah Mahmoud Ismaeil, Stuttgart (DE); Daria Stepanova, Leonberg (DE); Trung Kien Tran, Stuttgart (DE)

(21) Appl. No.: 18/660,402

(22) Filed: May 10, 2024

(30) Foreign Application Priority Data
May 22, 2023 (DE) 10 2023 204 758.6

(51) Int. Cl. G06N 5/04; G06N 5/02

(52) U.S. Cl. CPC G06N 5/04; G06N 5/02

(57) ABSTRACT

A device and computer implemented method for machine learning. The method includes providing an embedding of an entity of a knowledge graph, determining a set of features for the entity depending on the knowledge graph, and providing the entity with a feature from the set of features that is selected depending on a score that is assigned to the feature with a model. The model is configured to map the set of features to a prediction for the embedding of the entity and to determine the score depending on a difference between the prediction and the embedding.

### CROSS REFERENCE

The present application claims the benefit under 35 U.S.C. § 119 of German Patent Application No. DE 10 2023 204 758.6 filed on May 22, 2023, which is expressly incorporated herein by reference in its entirety.

### FIELD

The present invention relates to a device and a computer-implemented method for machine learning.

### SUMMARY

According to the present invention, the computer implemented method and the device for machine learning generate model explanations for knowledge graph embeddings or knowledge graph embedding models, i.e., interpretable representations of entities that perform similarly to the original entity embeddings in particular on specific pre-defined tasks.

According to an example embodiment of the present invention, the computer implemented method includes providing an embedding of an entity of a knowledge graph, determining a set of features for the entity depending on the knowledge graph, and providing the entity with a feature from the set of features that is selected depending on a score that is assigned to the feature with a model, wherein the model is configured to map the set of features to a prediction for the embedding of the entity and to determine the score depending on a difference between the prediction and the embedding. Given the knowledge graph and the embeddings of its entities pre-computed by any given model, the method generates interpretable features for the entities that approximates the respective embedding. The interpretable features comprise for example a Boolean feature vector. The obtained feature vectors encode the information extracted from a neighborhood of entities.

According to an example embodiment of the present invention, determining the set of features may comprise determining at least one feature depending on at least one relation or at least one entity of the knowledge graph. This feature provides an explanation based on the relation or entity.

According to an example embodiment of the present invention, determining the set of features may comprise determining at least one feature to comprise information about a relation that the entity has in the knowledge graph with another entity of the knowledge graph, and/or information about another entity of the knowledge graph that has a relation in the knowledge graph with the entity, and/or information about another entity or a relation that is present in the knowledge graph in a predetermined neighborhood of the entity, and/or information about an amount of the relations that the entity has to another entity of the knowledge graph or to other entities in the knowledge graph, and/or information about an amount of relations or entities that are present in the knowledge graph in a predetermined neighborhood of the entity. These features provide an explanation based on the existence of relations or entities in the knowledge graph.

According to an example embodiment of the present invention, providing the set of features may comprise providing the information about the amount to indicate a number of outgoing relations or incoming relations assigned to the entity in the knowledge graph. These features provide an explanation based on a statistic for the relations.

According to an example embodiment of the present invention, determining the set of features may comprise determining at least one feature to comprise information about an inexistence of a relation of the entity in the knowledge graph with another entity of the knowledge graph, and/or information about an inexistence of another entity of the knowledge graph that has a relation in the knowledge graph with the entity, and/or information about an absence of another entity or a relation in the knowledge graph in a predetermined neighborhood of the entity. These features provide an explanation based on the inexistence or absence of relations or entities in the knowledge graph.

According to an example embodiment of the present invention, the knowledge graph may comprise relations with labels, wherein providing the set of features comprises determining the information about the relation or the entity or the other entity to indicate a label of the relation. This feature provides an explanation based on the label.

According to an example embodiment of the present invention, providing the set of features may comprise providing a feature that either indicates at least one path, in particular of a given length, that has the entity as starting point or as end point in the at least one path, or that indicates no path, in particular of a given length, exists that has the entity as starting point or as end point in the at least one path. This feature provides an explanation based on the path or the paths.

According to an example embodiment of the present invention, the method may comprise assigning a respective score with the model to a plurality of the features of the set of features, determining an average of the scores that are assigned to the plurality of features, and selecting the feature from the set of features depending on a result of a comparison between the average and the score that is assigned to the feature. Thus, the explanation is based on the most relevant features. The explanation may be based on the features having a score that is larger than a threshold.

According to an example embodiment of the present invention, the entity may represent an event in a technical system, wherein the knowledge graph relates the entity to an entity of the knowledge graph that represents a category of the event, wherein the knowledge graph relates the entity that represents the category to at least one other entity that represents a different event in the technical system or another technical system, wherein the method comprises detecting an event that occurs in the technical system, actuating the technical system or detecting a failure of the technical system automatically depending on a comparison between the feature and a predetermined feature that is assigned to the at least one other entity. Thus, the technical system is operated automatically in an explainable manner.

According to an example embodiment of the present invention, the device for determining an encoding of entities of a knowledge graph comprises at least one processor and at least one memory, wherein the at least one memory stores instructions that are executable by the at least one processor and that, when executed by the at least one processor, cause the device to execute the method of the present invention.

According to an example embodiment of the present invention, a computer program comprises instructions that are executable by a computer and that, when executed by the computer; cause the computer to execute the method of the present invention.

Further embodiments of the present invention are derived from the following description and the figures.

### BRIEF DESCRIPTION OF THE DRAWINGS

FIG. 1 schematically depicts a device for operating a technical system, according to an example embodiment of the present invention.

FIG. 2 schematically depicts an exemplary knowledge graph, according to the present invention.

FIG. 3 schematically depicts a fragment of the exemplary knowledge graph, according to the present invention.

FIG. 4 schematically depicts an exemplary feature vector for an entity of the fragment, according to the present invention.

FIG. 5 schematically depicts exemplary features vectors for entities of the exemplary knowledge graph, according to the present invention.

FIG. 6 schematically depicts a numerical representation of entities of the exemplary knowledge graph, according to the present invention.

FIG. 7 schematically depicts the encoding of entities of the exemplary knowledge graph, according to the present invention.

FIG. 8 depicts a flowchart of a method, according to an example embodiment of the present invention.

### DETAILED DESCRIPTION OF EXAMPLE EMBODIMENTS

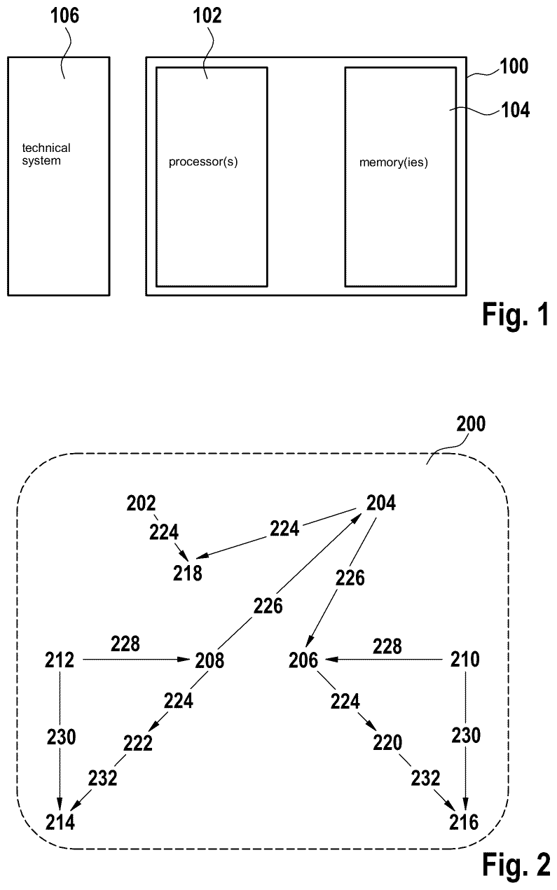

FIG. 1 schematically depicts a device 100.

The device 100 comprises at least one processor 102 and at least one memory 104. The at least one memory 104 stores instructions that are executable by the at least one processor 102 and that, when executed by the at least one processor 102, cause the device 100 to execute a method.

The device 100 may be configured to operate a technical system 106.

The technical system 106 is a physical system in the real world. The technical system 106 may be a robot. The technical system 106 may be a manufacturing machine, a vehicle, a home appliance, a power tool, a personal assist system or an entrance control system.

Events may occur in the technical system 106. An event may be a change in an internal machine state of the technical system 106 or a change in an environment of the technical system 106.

The technical system 106 may comprise a sensor or a controller for detecting the event. The device 100 may comprise a sensor for detecting the event.

The device 100 is configured for determining an encoding [symbol] (E) of entities E of a knowledge graph G.

The knowledge graph G may comprise entities that represent events and entities that represent categories of events. The knowledge graph G may comprise relations that indicate a relation between an entity that represents an event and an entity that represents a category. The entities E are represented by nodes of the knowledge graph G. The knowledge graph G comprises edges. A relation between two entities is represented by an edge that is associated with the relation and that connects two nodes that represent the two entities.

The encoding [symbol] (E) is determined depending on p features F={f₁, . . . , fₚ} for n entities E=e₁, . . . , eₙ and depending on a numerical representation ε(E) of the entities E. The numerical representation ε(E) is for example a predetermined knowledge graph embedding of the knowledge graph G. The numerical representation is a knowledge graph embedding model ε:E→ [symbol] ^{d} wherein d is the Dimension of the embedding.

The features F encode information about m relations R={r₁, . . . , rₘ} that are assigned to the entities E in the knowledge graph G.

The knowledge graph G represents factual information for example encoded a set of <subject, predicate, object>tripels or in logic format predicate (subject, object).

The knowledge graph G comprises for example more than 100, more than 1000, more than 10000 or more than 100000 entities.

The knowledge graph G comprises for example more than 100, more than 1000, more than 10000 or more than 100000 relations.

The knowledge graph embedding model E may be evaluated with a deep learning method, that is configured for link prediction or entity classification.

The features that are assigned to a given entity eᵢ are represented for example by a feature vector vᵢ that is assigned to the entity eᵢ.

The encoding [symbol] (E)={ [symbol] (e₁), . . . , [symbol] (eₙ)} of the entities E is determined depending on the features F such that a function W exists that maps the encoding [symbol] (E) of the entities E to the numerical representation ε(E) of the entities E. The features F or the feature vectors vᵢ may be determined together with the encoding [symbol] (E).

The function W is for example a regression model that is cable of providing insights about the importance of each part of its input for its predictions. The function W takes as its input for example a vector of features F that is built from entities E, relations R and edges of the knowledge graph, and learns to regenerate specific knowledge graph node embeddings from this input. The knowledge graph node embeddings belong to the knowledge graph embedding model E that is interpreted.

FIG. 2 schematically depicts an exemplary knowledge graph 200 with n=11 entities and m=5 relations.

The knowledge graph 200 comprises a first entity 202 e.g. representing a first manufacturer, a second entity 204 e.g. representing a second manufacturer, a third entity 206 e.g. representing a third manufacturer, a fourth entity 208 e.g. representing a fourth manufacturer, a fifth entity 210 e.g. representing a first individual, a sixth entity 212 e.g. representing a second individual, a seventh entity 214 e.g. representing a first country, an eighth entity 216 e.g. representing a second country, a ninth entity 218 e.g. representing a first product, a tenth entity 220 e.g. representing a second product, an eleventh entity 222 e.g. representing a third product.

The knowledge graph 200 comprises a first directed relation 224 e.g. “produces”, a second directed relation 226 e.g. “competitorOf”, a third directed relation 228 e.g. “workAt”, a fourth directed relation 230 e.g. “livesIn” and a fifth directed relation 232 e.g. “exportedTo”.

The first entity 202 and the ninth entity 218 are connected by the first directed relation 224. The second entity 204 and the ninth entity 218 are connected by the first directed relation 224.

The fourth entity 208 and the second entity 204 are connected by the second directed relation 224. The third entity 206 and the tenth entity 220 are connected by the first directed relation 224. The fourth entity 208 and the eleventh entity 222 are connected by the first directed relation 224.

The second entity 204 and the third entity 206 are connected by the second directed relation 226.

The fifth entity 210 and the third entity 206 are connected by the third directed relation 226. The fifth entity 210 and the eighth entity 216 are connected by the fourth directed relation 230.

The sixth entity 212 and the fourth entity 208 are connected by the third directed relation 226. The sixth entity 212 and the seventh entity 214 are connected by the fourth directed relation 230.

The eleventh entity 222 and the seventh entity 214 are connected by the fifth directed relation 232. The tenth entity 220 and the eighth entity 216 are connected by the fifth directed relation 232.

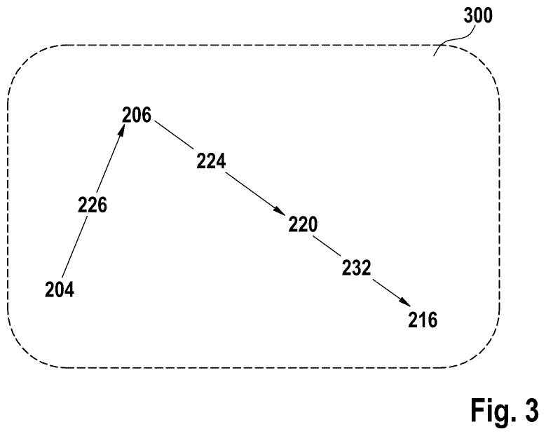

FIG. 3 schematically depicts a fragment 300 of the exemplary knowledge graph 200.

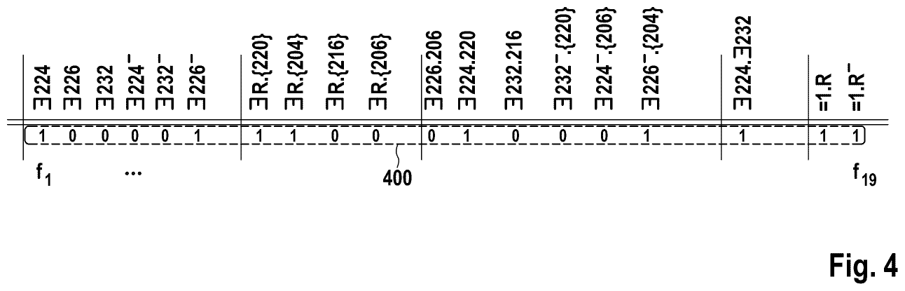

FIG. 4 schematically depicts an exemplary feature vector 400 for the third entity 206 of the fragment 300.

The feature vector 400 codes p=19 features F={f₁ . . . , f₁₉}. According to the example, 1 codes a feature that is TRUE and 0 codes a feature that is FALSE according to the knowledge graph 200. According to the example, R codes an outgoing directed relation with a label and R-codes an incoming directed relation with a label according to the knowledge graph 200.

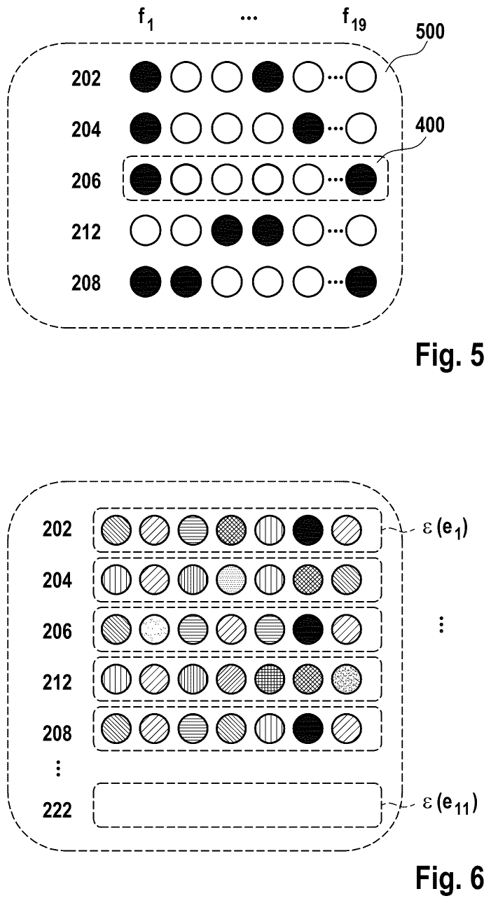

FIG. 5 schematically depicts exemplary features vectors 500 comprising the features F={f₁ . . . , f₁₉} for entities of the exemplary knowledge graph 200. In the feature vectors a circle filled black codes 1, i.e. TRUE, and a circle filled white codes 0, i.e. FALSE.

FIG. 6 schematically depicts an embedding 600 of the knowledge graph 200. The embedding 600 comprises the numerical representations ε(e₁), . . . , ε(e₁₁) of the entities E=e₁, . . . , e₁₁ of the exemplary knowledge graph 200 with the Dimension of the embedding d=7.

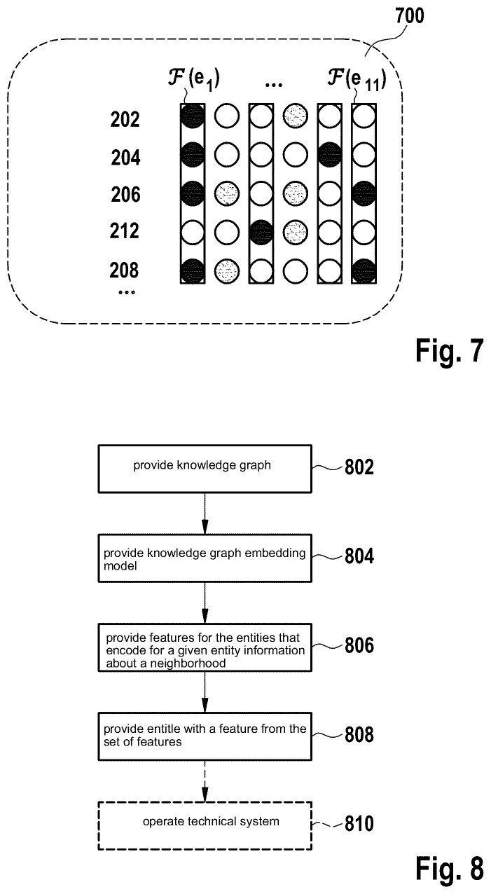

FIG. 7 schematically depicts an encoding 700, i.e. the encoding [symbol] (E)={ [symbol] (e₁), . . . , [symbol] (e₁₁)} of entities of the exemplary knowledge graph 200.

FIG. 8 depicts a flowchart of a method for determining the encoding [symbol] (E) of entities E.

The method comprises a step 802.

The step 802 comprises providing the knowledge graph G.

The knowledge graph G comprises entities E={e₁, . . . , eₙ} and m relations R={r₁, . . . , rₘ}. The knowledge graph G may comprises relations with labels.

The method may use embedding-based entity representation to compress the data in the knowledge graph G.

For example, the knowledge graph 200 is provided with the entities 202, . . . , 222 and the directed relations 224, . . . , 232.

The method comprises a step 804.

The step 804 comprises providing the knowledge graph embedding model ε:E→ [symbol] ^{d}.

The knowledge graph embedding model ε is configured to map the entities E to the numerical representation ε(E) of the entities E.

For example, numerical representations ε(e₁, . . . , e₁₁) for the entries e₁, . . . , e₁₁ are determined for the eleven entities 202, . . . , 222.

According to an example, the knowledge graph embedding model E is configured to map an entity e EE of the entities E to a numerical representation ε(e) of the entity e.

The method comprises a step 806.

The step 806 comprises providing the features F for the entities E that encode for a given entity information about a neighborhood of the given entity in the knowledge graph G. The neighborhood of an entity e is characterized in the example by the relations the entity e has and/or entities in the knowledge graph G that have a relation r∈R with the entity e. The neighborhood may comprise a single entity e′ that as a relation r with the entity e in the knowledge graph G.

At least one feature of the features may comprise information about an existence or inexistence of a relation of the entity in the knowledge graph with another entity of the knowledge graph.

At least one feature of the features may comprise information about an existence or inexistence of another entity of the knowledge graph that has a relation in the knowledge graph with the entity.

At least one feature of the features may comprise information about an existence or an absence of another entity or a relation in the knowledge graph in the predetermined neighborhood of the entity.

The method may comprising generating the features.

The method may use feature vector-based entity representation to compress the data in the knowledge graph G.

The method constructs a set of features for the entities E wherein the features for a specific entity e is based on its neighborhood in the knowledge graph G. The initial set of features can be either manually constructed or automatically computed e.g. using rule learning.

In an example, interpretable feature vector representations are determined for the entities, that could possibly be relevant for the knowledge graph embedding model ε.

According to an example, a feature f∈F of the features F for an entity e∈E of the entities E is determined depending on a relation r∈R of the relations R that is assigned to the entity e.

According to an example, a feature is provided that indicates whether an entity takes part in a given relation or not.

For a relation r there may be a feature ∃r that describes for an entity that it has an outgoing relation with the entity. For a relation r there may be feature ∃r⁻ that describes for an entity that it has an incoming relation with the entity.

According to an example, a feature is provided that either indicates at least one entity to that an entity is connected via a relation with a given label or that indicates no connection via a relation with a given label. For example ∃R{e′} describes for an entity that it has an outgoing relation with a label to an entity e′. For example ∃R⁻{e′} describes for an entity that it has an incoming relation with a label from an entity e′.

For the second entity 204 in the exemplary knowledge graph 200 the features are ∃R{220}, ∃R⁻{204}.

According to an example, a feature is provided that indicates whether an entity is connected to an entity via a given relation or not. For example ar. {e′} describes for an entity that it has an outgoing relation with an entity e′. For example ∃r⁻.{e′} describes for an entity that it has an incoming relation with an entity e′.

For the second entity 204 in the exemplary knowledge graph 200 the features are ∃224. {220}, ∃226⁻. {204}.

According to an example, a feature is provided that either indicates a path, in particular of a given length k, that has a given entity as starting point or as end point in the path.

For the third entity 206 in the exemplary knowledge graph 200 and k=2, one path feature for the third entity 206 is ∃224.∃232.

According to an example, a feature is provided that either indicates there exists no path, in particular of a given length k, in the knowledge graph that has a given entity as starting point or as end point in the path.

According to an example, a feature is provided that indicates an amount of outgoing relations or incoming relations for an entity.

For example, the notation=k. R may be used for constructors:

$$\geq k . R ⊓ \leq k . R$$

For example, the notation=k. R⁻ may be used for constructors:

$$\geq k . {R}^{-} ⊓ \leq k . {R}^{-}$$

For example, for the third entity 206 in the exemplary knowledge graph 200, the features are =1.R and =1. R⁻ as there is 1 outgoing and 1 incoming relation for the third entity 206.

The p features may be collected into the set F={f₁, . . . , fₚ}. For the entities interpretable Boolean vectors may be determined, wherein one interpretable Boolean vector fvₑ={f₀^{e}, . . . , fₚ^{e}} is determined for one entity and such that |fvₑ|=|F| and fᵢ^{e}=1 if the feature fᵢ holds for the entity e in the knowledge graph G and fᵢ^{e}=0 otherwise.

The exemplary feature vector 400 comprises the p=19 features for the third entity 206.

The method comprises a step 808.

The step 808 comprises providing the entity with a feature from the set of features.

The entity of the knowledge graph is provided with a feature from the set of features that is selected depending on a score that is assigned to the feature with a model. The entity may be provided with several features from the set of features that are selected depending on their respective score.

The model is configured to map the set of features to a prediction for the embedding of the entity and to determine the score depending on a difference between the prediction and the embedding.

The method may comprise providing a plurality of entities of the knowledge graph with a respective feature or with respective features in order to interpret the knowledge graph embedding or the knowledge graph embedding model.

The model is configured in the example for determining the encoding [symbol] (E) of the entities E depending on the features F such that the function W exists that maps the encoding [symbol] (E) of the entities E to the numerical representation ε(E) of the entities E.

The model may be a random forest regression model that is configured to determine the prediction for the embedding depending on the set of features.

The method may use training of the random forest regression model on the task of reconstructing entity embeddings, i.e. the numerical representation ε(E), from feature vector-based entity representations, i.e. the encoding [symbol] (E).

According to an example, the encoding [symbol] (E) of the entities E is determined depending on the features F such that the function W exists that maps the encoding [symbol] (e) of the entity e to the numerical representation ε(e) of the entity e.

The encoding [symbol] (E) of the entities E may be determined depending on features that are selected from the features F.

The method may select from the obtained features F those that capture the information stored in entity embeddings ε(e).

The method may use an embedded feature selection technique for selecting features. For example, a subset of interpretable features for which the random forest regression model achieves the highest accuracy on the respective task is selected.

The features F may be selected depending on their importance for the encoding [symbol] (E). The score in the example indicates the relevance.

According to one example, the model M for mapping the features F to the numerical representation ε(E) of the entities E is provided.

The model M is configured to output the score indicative of an importance a feature f∈F of the features F for the mapping.

The score is for example determined depending on an error of the mapping, e.g. a squared error between the mapping of the features F with the model model M the numerical representation ε(E) of the entities E.

This means that the encoding [symbol] (E) of the entities E may be determined depending on the features F.

For example, the encoding [symbol] (E) of the entities E is determined depending on the feature f if the score for the feature f exceeds a threshold. Otherwise, the encoding [symbol] (E) of the entities E is determined independent on the feature f.

The score is for example determined for a plurality of features. The threshold is for example an average of the scores that are determined for the plurality of features.

This means that the method may comprise assigning a respective score with the model to a plurality of the features of the set of features.

This means that the method may comprise determining the average of the scores that are assigned to the plurality of features.

This means that the method may comprise selecting the feature from the set of features depending on a result of a comparison between the average and the score that is assigned to the feature.

The knowledge graph embedding model ε(E) is an interpretable model that is helpful for in-depth model analysis and debugging purposes.

The method may comprise a step 810.

In the step 810, the technical system 106 is operated.

According to one example, the knowledge graph comprises a first entity that represents an event in the technical system 106 and a second entity that represents a different event in the technical system 106 or in a different technical system. The knowledge graph comprises for example an edge that connects a node of the knowledge graph that represents the first entity to another node of the knowledge graph that represents an entity of the knowledge graph that represents a category of the event. The knowledge graph for example relates the second entity to the entity that represents the category. The first entity is provided with a first feature or a first feature vector. The second entity is provided with a second feature or a second feature vector.

The step 810 may comprise detecting an event that occurs in the technical system 106.

The step 810 may comprise actuating the technical system 106 or detecting a failure of the technical system 106 automatically depending on a comparison between the feature and a predetermined feature that is assigned to the at least one other entity.

Once the first entity and the second entity have been classified to a particular category the method may automatically identify the common feature or features that these entities are provided with.

The common feature or features provide a possible explanation for the respective classification result.

The absence of any common feature may indicate an erroneous assignment of one of the events to the category. The presence of at least one common feature may indicate a correct assignment of the events to the category. A common feature may provide an explanation indicating which part of the technical system 106 or operation of the technical system 106 caused the event.

In case a common feature or features provide a possible explanation for the respective classification result, the technical system 106 may be actuated according to an action that is given by a category upon detection of an event that is assigned in the knowledge graph to the category.

In case a common feature or features provide a possible explanation for the respective classification result, the technical system 106 may be stopped upon detection of an event that is assigned in the knowledge graph to a category indicating a failure.

A use case for the method e.g. in the manufacturing domain comprises classifying failure events into certain categories (e.g., high risk, low risk).

A prediction of the failure event is determined with the encoding [symbol] (E). Apart from the general analysis of the failure event, i.e. the classification in one of the categories high risk or low risk, the encoding [symbol] (E) generates an explanation for the respective prediction as follows.

Once a given entity eᵢ, that represents the failure event, has been classified to a particular class c, representing either high risk or low risk, relying on the knowledge graph embedding model ε(E), the feature vector vᵢ of eᵢ is generated with the method and compared to feature vectors of entities that are known to belong to the class c. Based on the respective feature vectors, the features fᵢ that eᵢ shares with the other entities of the class c; these features amount to a possible explanation for the respective classification result.

What is claimed is:

1. A computer implemented method for machine learning, comprising the following steps:
providing an embedding of an entity of a knowledge graph;
determining a set of features for the entity depending on the knowledge graph; and
providing the entity with a feature from the set of features that is selected depending on a score that is assigned to the feature with a model, wherein the model is configured to map the set of features to a prediction for the embedding of the entity and to determine the score depending on a difference between the prediction and the embedding.

2. The method according to claim 1, wherein the determining of the set of features includes determining at least one feature depending on at least one relation or at least one entity of the knowledge graph.

3. The method according to claim 1, wherein the determining of the set of features includes:
determining at least one feature to include: (i) information about a relation that the entity has in the knowledge graph with another entity of the knowledge graph, and/or (ii) information about another entity of the knowledge graph that has a relation in the knowledge graph with the entity, and/or (iii) information about another entity or a relation that is present in the knowledge graph in a predetermined neighborhood of the entity, and/or (iv) information about an amount of the relations that the entity has to another entity of the knowledge graph or to other entities in the knowledge graph, and/or (v) information about an amount of relations or entities that are present in the knowledge graph in a predetermined neighborhood of the entity.

4. The method according to claim 3, wherein the providing of the set of features includes providing the information about the amount to indicate a number of outgoing relations or incoming relations assigned to the entity in the knowledge graph.

5. The method according to claim 1, wherein the determining of the set of features includes:
determining at least one feature to include information about an inexistence of a relation of the entity in the knowledge graph with another entity of the knowledge graph, and/or information about an inexistence of another entity of the knowledge graph that has a relation in the knowledge graph with the entity, and/or information about an absence of another entity or a relation in the knowledge graph in a predetermined neighborhood of the entity.

6. The method according to claim 1, wherein the knowledge graph includes relations with labels, and wherein the providing of the set of features includes determining information about the relation or the entity or the other entity to indicate a label of the relation.

7. The method according to claim 1, wherein the providing of the set of features includes providing a feature that either indicates at least one path of a given length that has the entity as starting point or as end point in the at least one path, or that indicates no path of a given length exists that has the entity as starting point or as end point in the at least one path.

8. The method according to claim 1, further comprising:
assigning a respective score with the model to a plurality of the features of the set of features;
determining an average of the scores that are assigned to the plurality of features; and
selecting the feature from the set of features depending on a result of a comparison between the average and the score that is assigned to the feature.

9. The method according to claim 1, wherein the entity represents an event in a technical system, wherein the knowledge graph relates the entity to an entity of the knowledge graph that represents a category of the event, wherein the knowledge graph relates the entity that represents the category to at least one other entity that represents a different event in the technical system or another technical system, wherein the method further comprises:
detecting an event that occurs in the technical system;
actuating the technical system or detecting a failure of the technical system automatically, depending on a comparison between the feature and a predetermined feature that is assigned to the at least one other entity.

10. A device for machine learning, comprising:
at least one processor; and
at least one memory, wherein the at least one memory stores instructions that are executable by the at least one processor for machine learning, the instructions, when executed by the at least one processor, causing the at least one processor to perform the following steps:
providing an embedding of an entity of a knowledge graph,
determining a set of features for the entity depending on the knowledge graph, and
providing the entity with a feature from the set of features that is selected depending on a score that is assigned to the feature with a model, wherein the model is configured to map the set of features to a prediction for the embedding of the entity and to determine the score depending on a difference between the prediction and the embedding.

11. A non-transitory computer-readable storage medium on which is stored a computer program including instructions for machine learning, the instructions, when executed by a computer, causing the computer to perform the following steps:
providing an embedding of an entity of a knowledge graph;
determining a set of features for the entity depending on the knowledge graph; and
providing the entity with a feature from the set of features that is selected depending on a score that is assigned to the feature with a model, wherein the model is configured to map the set of features to a prediction for the embedding of the entity and to determine the score depending on a difference between the prediction and the embedding.
